(19) United States
(12) Patent Application Publication
(10) Pub. No.: US 2026/0257504 A1
(43) Pub. Date: Sep. 3, 2026

(54) PRINTING APPARATUS

(71) Applicant: Konica Minolta, Inc., Tokyo (JP)

(72) Inventor: Takahiro HARA, Tokyo (JP)

(21) Appl. No.: 19/545,969

(22) Filed: Feb. 20, 2026

(30) Foreign Application Priority Data
Feb. 28, 2025 (JP) 2025-031609

(51) Int. Cl. B41J 13/22; B41J 13/00; B41J 13/02

(52) U.S. Cl. CPC B41J 13/22; B41J 13/0027; B41J 13/02

(57) ABSTRACT

A printing apparatus includes: a conveyer that conveys a recording medium in a conveyance direction in a state where a leading end portion of the recording medium is gripped and held by a gripping claw; a printer that performs printing on the recording medium being conveyed; a gripping state detector that detects a gripping state of the gripping claw with respect to an recording medium; and a determiner that determines presence or absence of abnormality in the gripping state of the gripping claw based on a detection result of the gripping state detector.

### CROSS REFERENCE TO RELATED APPLICATIONS

Japanese Patent Application No. 2025-031609 filed on Feb. 28, 2025, including description, claims, drawings, and abstract the entire disclosure is incorporated herein by reference in its entirety.

### BACKGROUND

### Technological Field

The present invention relates to a printing apparatus.

### Description of Related Art

As a prior art of a printing apparatus such as an offset sheet-fed printing machine, for example, there is one disclosed in Japanese Unexamined Patent Publication No. 2002-264301. The printing apparatus described in Japanese Unexamined Patent Publication No. 2002-264301 includes a conveyance section that conveys a sheet-shaped recording medium such as a paper sheet in a conveyance direction in a state where a leading end portion of the recording medium is gripped and held by gripping claws. The conveyance section includes a blanket cylinder, an impression cylinder, a first transfer cylinder, a second transfer cylinder, and a reversing cylinder, and the blanket cylinder and the impression cylinder have a function as a printing section to print on a recording medium being conveyed.

### SUMMARY

However, in the printing apparatus disclosed in Japanese Unexamined Patent Publication No. 2002-264301, if the amount of gripping of the gripping claws with respect to the recording media is too small, the force with which the recording media are held by the gripping claws becomes insufficient, and there is a risk that the recording media will fall off from the conveyance section. In addition, in a case where the gripping amount of the gripping claws with respect to the recording medium is excessive, the leading end of the recording medium interferes with the base of the gripping claws, and thus damage such as a fold or a tear may occur in the leading end portion of the recording medium.

Objectives of some aspects of the invention include providing a printing apparatus capable of suppressing damage to a leading end portion of a recording medium while suppressing the recording medium from falling off from a conveyance section.

In order to realize at least one of the above-described objectives, a printing apparatus reflecting one aspect of the present invention includes:

a conveyer that conveys a recording medium in a conveyance direction in a state where a leading end portion of the recording medium is gripped and held by a gripping claw;

a printer that performs printing on the recording medium being conveyed;

a gripping state detector that detects a gripping state of the gripping claw with respect to a recording medium; and

a determiner that determines presence or absence of abnormality in the gripping state of the gripping claw based on a detection result of the gripping state detector.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic front view of the inkjet printing apparatus according to the present embodiment;

FIG. 2 is a schematic enlarged view of a portion II in FIG. 1;

FIG. 3 is a schematic diagram when viewed from a part III in FIG. 2;

FIG. 4A is a diagram illustrating a captured image in a case where there is no abnormality in a gripping state of a plurality of gripping claws with respect to a front surface of a recording medium;

FIG. 4B is a diagram illustrating a captured image in a case where there is an abnormality in the gripping state of a plurality of gripping claws with respect to the front surface of the recording medium;

FIG. 4C is a diagram illustrating a captured image in a case where there is an abnormality in the gripping state of a plurality of gripping claws with respect to the front surface of the recording medium;

FIG. 4D is a diagram illustrating a captured image in a case where there is an abnormality in the gripping state of a plurality of gripping claws with respect to the front surface of the recording medium;

FIG. 5A is a diagram illustrating a captured image in a case where there is no abnormality in a gripping state of a plurality of gripping claws with respect to a back surface of a recording medium;

FIG. 5B is a diagram illustrating a captured image in a case where there is an abnormality in the gripping state of a plurality of gripping claws with respect to the back surface of the recording medium; and

FIG. 6 is a control block diagram of the ink jet printing apparatus according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, the present embodiment will be described with reference to the drawings. In the present embodiment, the conveyance direction refers to a direction in which a recording medium is conveyed. The downstream side is a downstream side in the conveyance direction, and the upstream side is an upstream side in the conveyance direction. The conveyance width direction is a direction orthogonal to the conveyance direction. Further, in the drawings, "FD" denotes the conveyance direction, and "WD" denotes the conveyance width direction.

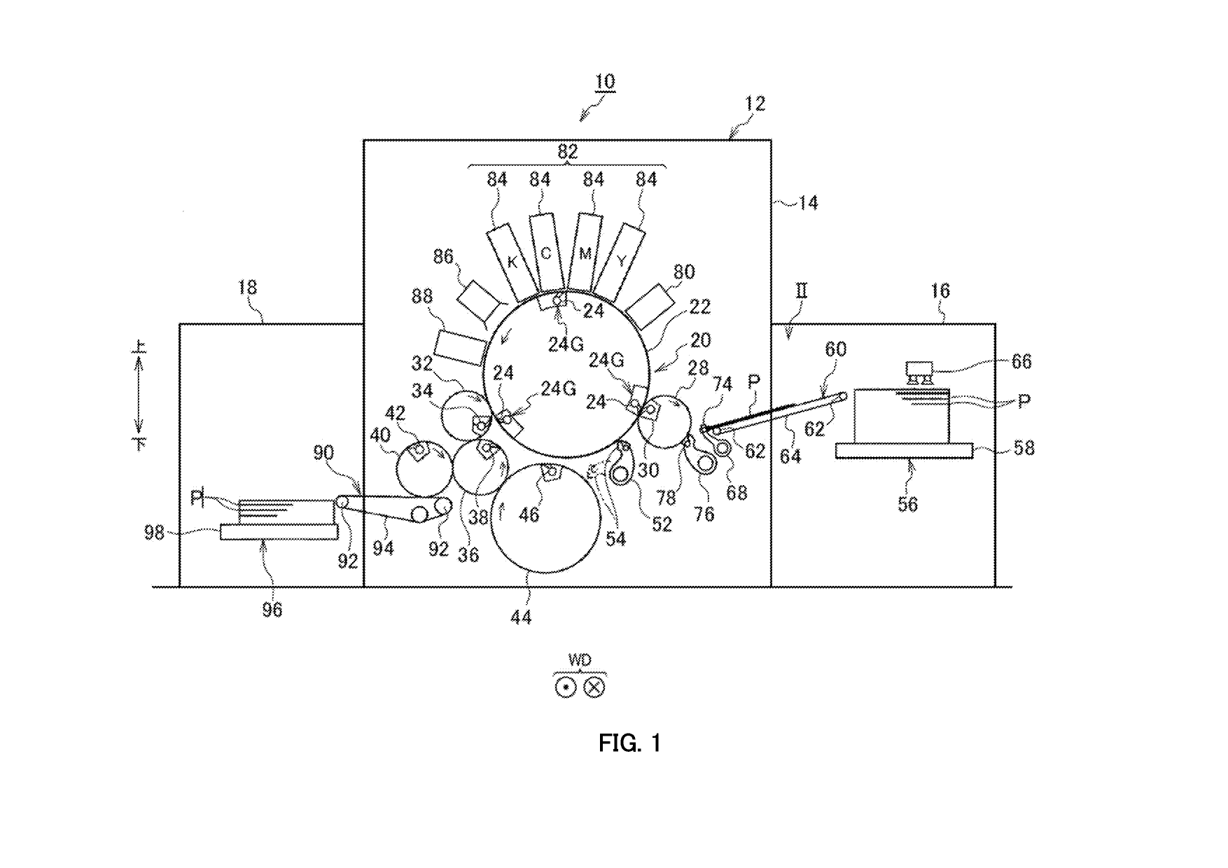

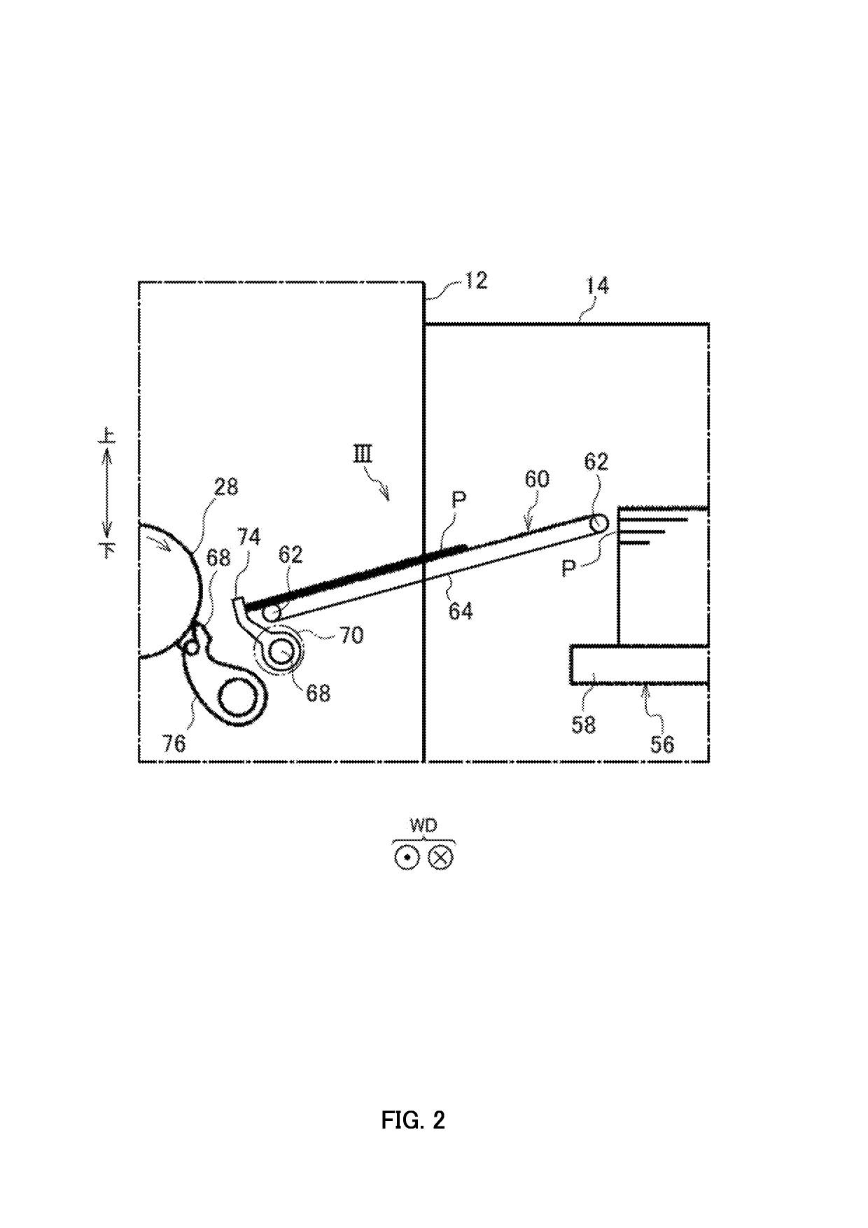

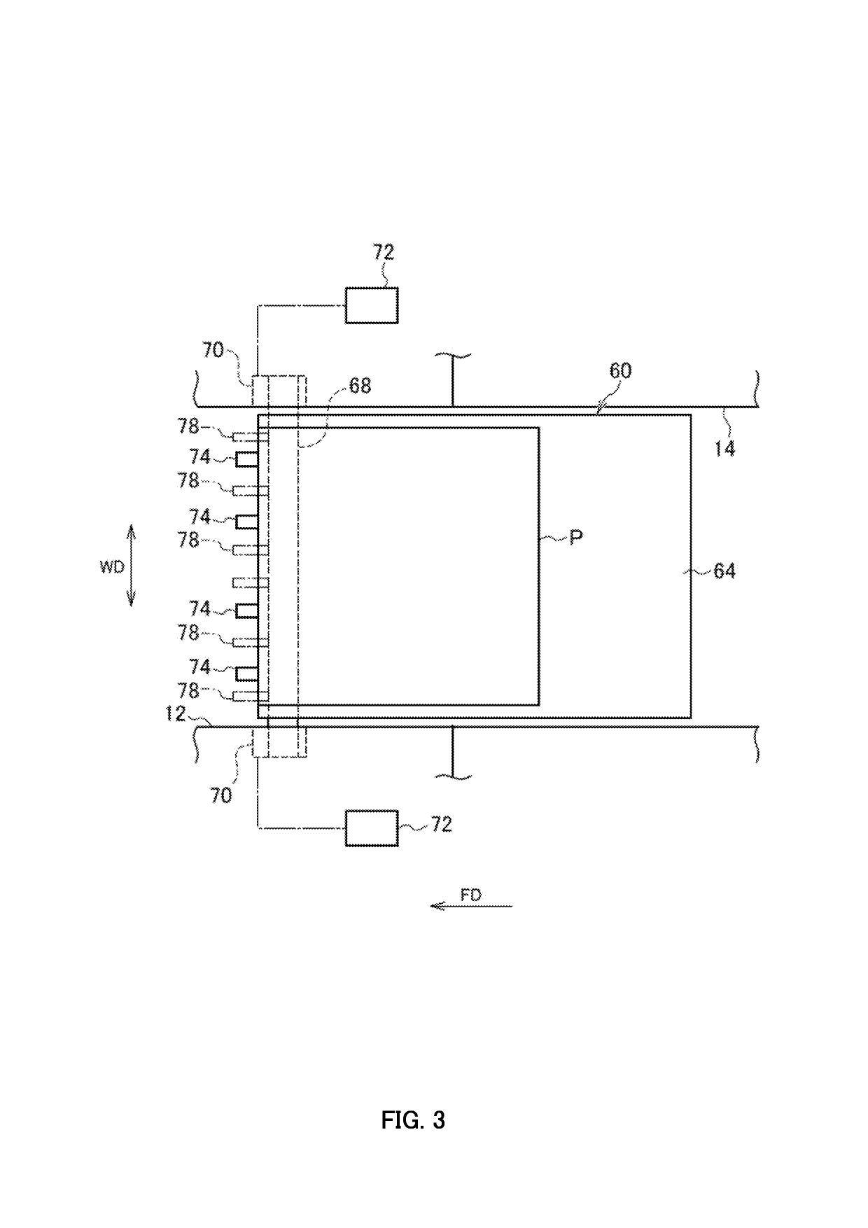

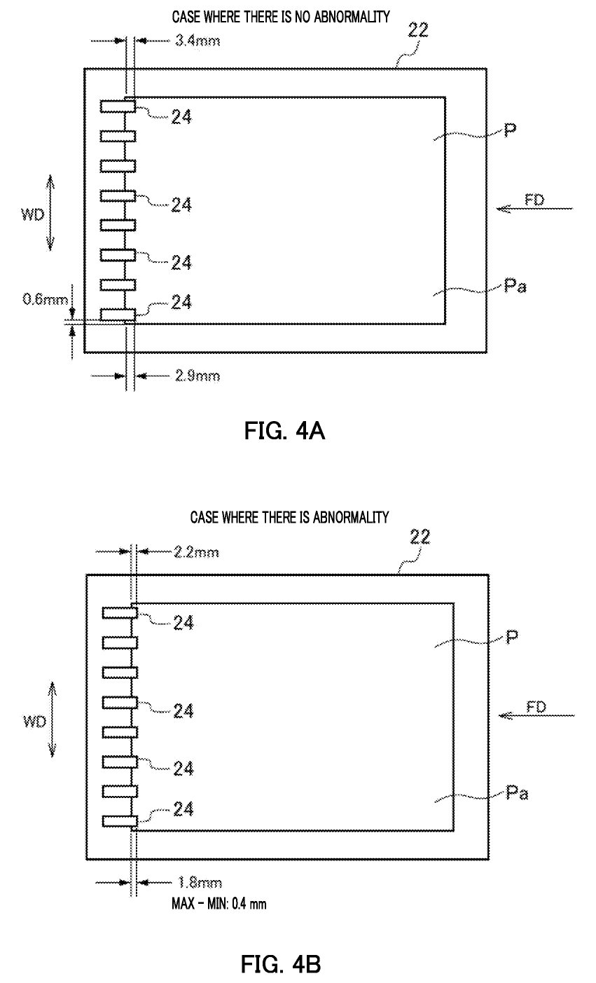

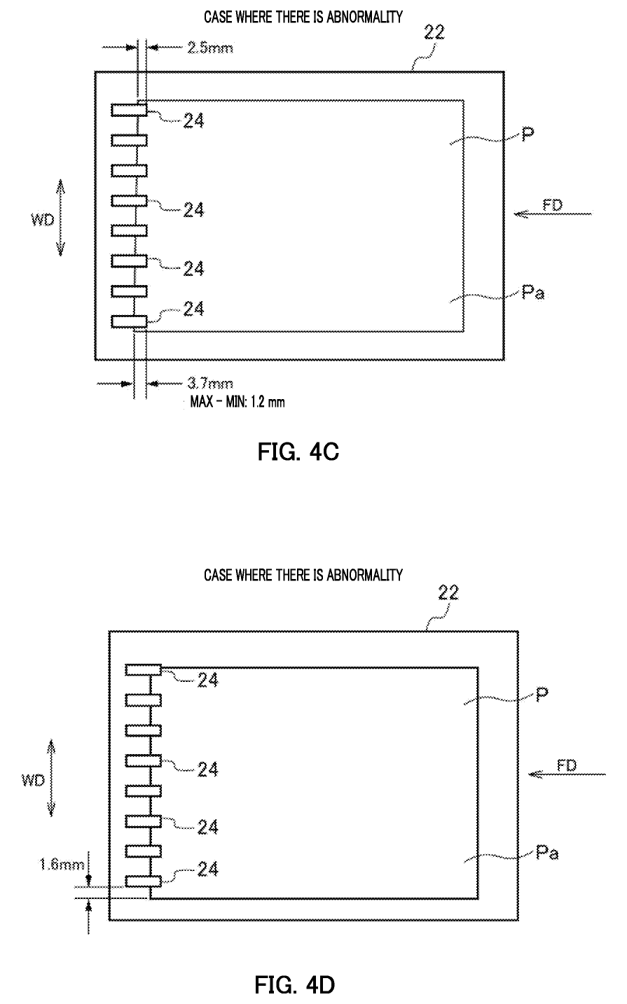

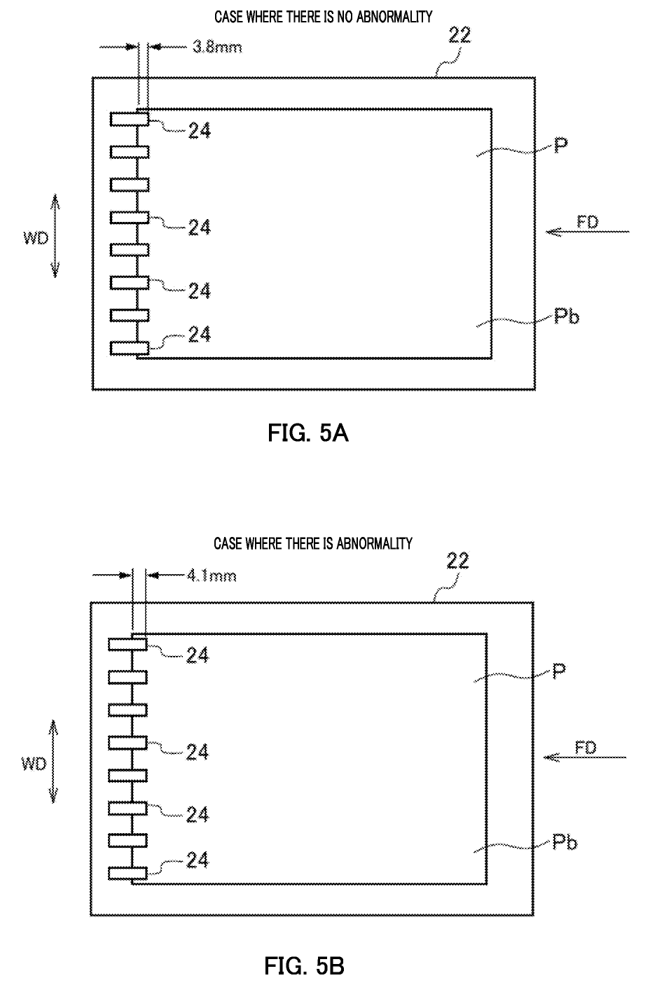

With reference to FIGS. 1 to 5B, the configuration of an inkjet printing apparatus 10 according to the present embodiment is described. FIG. 1 is a schematic front view of an inkjet printing apparatus 10 according to the present embodiment. FIG. 2 is a schematic enlarged view of a portion II in FIG. 1. FIG. 3 is a schematic diagram when viewed from a part III in FIG. 2. FIG. 4A is a diagram illustrating a captured image in a case where there is no abnormality in the gripping states of the plurality of gripping claws 24 with respect to the front surface Pa of the recording medium P. FIGS. 4B to 4D are diagrams illustrating captured images in a case where there is an abnormality in the gripping state of the plurality of gripping claws 24 with respect to the front surface Pa of the recording medium P. FIG. 5A is a diagram illustrating a captured image in a case where there is no abnormality in the gripping states of the plurality of gripping claws 24 with respect to the back surface Pb of the recording medium P. FIG. 5B is a diagram illustrating a captured image in a case where there is an abnormality in the gripping state of the plurality of gripping claws 24 with respect to the back surface Pb of the recording medium P.

As shown in FIG. 1, the inkjet printing apparatus 10 according to the present embodiment is a single-pass printing apparatus that performs printing (image formation) on a sheet-shaped recording medium P while conveying the recording medium P in a conveyance direction. As the recording medium P, in addition to paper such as plain paper and coated paper, various media such as textiles and resin films can be used.

The inkjet printing apparatus 10 includes a printing apparatus main body 12 extending in a right-left direction in FIG. 1. The printing apparatus main body 12 includes a center frame 14, a first side frame 16 disposed on one side of the center frame 14, and a second side frame 18 disposed on the other side of the center frame 14.

The inkjet printing apparatus 10 includes a conveyance section 20 that conveys a sheet-shaped recording medium P in a conveyance direction, and the conveyance section 20 is provided in the center frame 14. Then, a specific configuration of the conveyance section 20 is as follows.

As illustrated in FIG. 1, the conveyance section 20 includes a printing cylinder 22 rotatably provided in the center frame 14, and the printing cylinder 22 rotates while carrying the recording medium P. A plurality of gripping claws 24 for gripping and holding a leading end portion of the recording medium P are provided on an outer peripheral surface side of the printing cylinder 22. The plurality of gripping claws 24 of the printing cylinder 22 are divided into a plurality of (for example, three) claw groups 24G, and the plurality of claw groups 24G are arranged at equal intervals on the outer peripheral surface of the printing cylinder 22. A plurality of gripping claws 24 (only one of which is shown) of each claw group 24G of the printing cylinder 22 are arranged at intervals along the conveyance width direction. Note that the gripping claw 24 is also referred to as a holding claw that holds the leading end portion of the recording medium P.

On the outer peripheral surface of the printing cylinder 22, a plurality of adsorption sections (not illustrated) to adsorb the recording medium P are provided. The adsorption method of the plurality of adsorption sections of the printing cylinder 22 may be either suction adsorption or electrostatic adsorption.

The conveyance section 20 includes a rotary motor 26 (see FIG. 4) as a drive source to rotate the printing cylinder 22, and the rotary motor 26 is provided at an appropriate position of the center frame 14. The recording media P are conveyed in the conveyance direction by rotating the printing cylinder 22 by driving the rotary motor 26 in a state in which the leading end portions of the recording media P are gripped and held by the plurality of gripping claws 24 of any one of the claw groups 24G of the printing cylinder 22.

As shown in FIG. 1, the conveyance section 20 has an upstream cylinder 28 that delivers the recording medium P to the printing cylinder 22, and the upstream cylinder 28 is rotatably provided on the upstream side of the printing cylinder 22 in the center frame 14. The upstream cylinder 28 is disposed adjacent to the printing cylinder 22, and rotates while carrying the recording medium P. The upstream cylinder 28 is configured to rotate in a direction opposite to the rotation direction of the printing cylinder 22 in conjunction with the rotation of the printing cylinder 22. The diameter of the upstream cylinder 28 is 1/3 of the diameter of the printing cylinder 22, and the upstream cylinder 28 is configured to make one revolution when the printing cylinder 22 makes 1/3 revolutions.

A plurality of gripping claws 30 (only one gripping claw 30 is illustrated) for gripping and holding a leading end portion of the recording medium P are provided on an outer peripheral surface side of the upstream cylinder 28. The plurality of gripping claws 30 of the upstream cylinder 28 are disposed at intervals in the conveyance width direction. The plurality of gripping claws 30 of the upstream cylinder 28 and the plurality of gripping claws 24 of any one of the claw groups 24G of the printing cylinder 22 perform the gripping change operation of the recording media P in a state of being close to each other. The plurality of gripping claws 24 of any one of the claw groups 24G of the printing cylinder 22 receive and hold the leading end portion of the recording media P from the gripping claws 30 of the upstream cylinder 28. Note that the gripping claws 30 are also referred to as holding claws that hold the leading end portion of the recording medium P.

As illustrated in FIG. 1, the conveyance section 20 includes a first downstream cylinder 32 that receives the recording medium P having undergone single-sided printing or double-sided printing from the printing cylinder 22. The first downstream cylinder 32 is rotatably provided on the downstream side of the printing cylinder 22 in the center frame 14. The first downstream cylinder 32 is disposed close to the printing cylinder 22, and rotates while carrying the recording medium P. The first downstream cylinder 32 is configured to rotate in a direction opposite to the rotation direction of the printing cylinder 22 in conjunction with the rotation of the printing cylinder 22. The diameter of the first downstream cylinder 32 is 1/3 of the diameter of the printing cylinder 22, and the first downstream cylinder 32 is configured to make one revolution when the printing cylinder 22 makes 1/3 revolutions.

A plurality of gripping claws 34 (only one gripping claw 34 is shown) for gripping and holding the leading end portion of the recording medium P are provided on the outer peripheral surface side of the first downstream cylinder 32. The plurality of gripping claws 34 of the first downstream cylinder 32 are disposed at intervals in the conveyance width direction. The plurality of gripping claws 34 of the first downstream cylinder 32 and the plurality of gripping claws 24 of any one of the claw groups 24G of the printing cylinder 22 perform the gripping change operation of the recording media P in a state of being close to each other. The plurality of gripping claws 24 of the first downstream cylinder 32 receive and hold the leading end portion of the recording media P having undergone single-sided printing or double-sided printing from the gripping claws 24 of any one of the claw groups 24G of the printing cylinder 22. Note that the gripping claws 34 are also referred to as holding claws that hold the leading end portion of the recording medium P.

As shown in FIG. 1, the conveyance section 20 includes a second downstream cylinder 36 that receives the recording medium P on which single-sided printing or double-sided printing has been performed from the first downstream cylinder 32. The second downstream cylinder 36 is rotatably provided on the downstream side of the first downstream cylinder 32 in the center frame 14. The second downstream cylinder 36 is disposed adjacent to the first downstream cylinder 32, and rotates while carrying the recording medium P. The second downstream cylinder 36 is configured to rotate in the same direction as the rotation direction of the printing cylinder 22 in conjunction with the rotation of the printing cylinder 22. The diameter of the second downstream cylinder 36 is 1/3 of the diameter of the printing cylinder 22, and the first downstream cylinder 32 is configured to rotate once when the printing cylinder 22 rotates 1/3 times.

On the outer peripheral surface side of the second downstream cylinder 36, a plurality of gripping claws 38 (only one gripping claw 38 is illustrated) are disposed to grip and hold the leading end portion of the recording medium P. The plurality of gripping claws 38 of the second downstream cylinder 36 are disposed at intervals in the conveyance width direction. The plurality of gripping claws 38 of the second downstream cylinder 36 and the plurality of gripping claws 34 of the first downstream cylinder 32 perform a grip change operation of the recording medium P in a state of being close to each other. The plurality of gripping claws 38 of the second downstream cylinder 36 receive and hold the leading end portion of the recording medium P subjected to single-sided printing or double-sided printing from the plurality of gripping claws 34 of the first downstream cylinder 32. Note that the gripping claws 38 are also referred to as holding claws that hold the leading end portion of the recording medium P.

As illustrated in FIG. 1, the conveyance section 20 includes a third downstream cylinder 40 that receives the recording medium P having undergone single-sided printing or double-sided printing from the second downstream cylinder 36. The third downstream cylinder 40 is rotatably provided on the downstream side of the second downstream cylinder 36 in the center frame 14. The third downstream cylinder 40 is disposed close to the second downstream cylinder 36, and rotates while carrying the recording medium P. The third downstream cylinder 40 is configured to rotate in a direction opposite to the rotation direction of the printing cylinder 22 while interlocking with the rotation of the printing cylinder 22. The diameter of the third downstream cylinder 40 is 1/3 of the diameter of the printing cylinder 22, and the third downstream cylinder 40 is configured to make one revolution when the printing cylinder 22 makes 1/3 revolutions.

On the outer peripheral surface side of the third downstream cylinder 40, a plurality of gripping claws 42 (only one gripping claw 42 is illustrated) for gripping and holding the leading end portion of the recording medium P are provided. The plurality of gripping claws 42 of the third downstream cylinder 40 are disposed at intervals in the conveyance width direction. The plurality of gripping claws 42 of the third downstream cylinder 40 and the plurality of gripping claws 38 of the second downstream cylinder 36 perform the gripping change operation of the recording medium P in a state of being close to each other. The plurality of gripping claws 42 of the third downstream cylinder 40 receive and hold the leading end portion of the recording medium P having undergone single-sided printing or double-sided printing from the plurality of gripping claws 38 of the second downstream cylinder 36. Note that the gripping claws 42 are also referred to as holding claws that hold the leading end portion of the recording medium P.

As illustrated in FIG. 1, the conveyance section 20 includes a pre-reversing cylinder 44 that receives the recording medium P having undergone single-sided printing from the third downstream cylinder 40. The pre-reversing cylinder 44 is rotatably provided on the center frame 14, and is arranged at a position facing the printing cylinder 22. The pre-reversing cylinder 44 is disposed close to the third downstream cylinder 40, and rotates while carrying the recording medium P. The pre-reversing cylinder 44 is configured to rotate in the same direction as the direction of rotation of the printing cylinder 22, independently of the rotation of the printing cylinder 22. The diameter of the pre-reversing cylinder 44 is 2/3 of the diameter of the printing cylinder 22.

A plurality of gripping claws 46 (only one gripping claw 46 is shown) for gripping and holding the leading end portion of the recording medium P are provided on the outer peripheral surface of the pre-reversing cylinder 44. The plurality of gripping claws 46 of the pre-reversing cylinder 44 are arranged at intervals in the conveyance width direction. The plurality of gripping claws 46 of the pre-reversing cylinder 44 and the plurality of gripping claws 42 of the third downstream cylinder 40 perform the gripping change operation of the recording medium P in a state of being close to each other. The plurality of gripping claws 46 of the pre-reversing cylinder 44 receive and hold the leading end of the recording medium P having undergone single-sided printing from the plurality of gripping claws 42 of the third downstream cylinder 40. Note that the gripping claws 46 are also referred to as holding claws that hold the leading end portion of the recording medium P.

On the outer peripheral surface of the pre-reversing cylinder 44, a plurality of attraction sections (not illustrated) to attract the recording medium P are provided. The adsorption method of the plurality of adsorption sections of the pre-reversing cylinder 44 may be either suction adsorption or electrostatic adsorption. Furthermore, the plurality of attraction sections of the pre-reversing cylinder 44 are connected to an attraction force adjustment section 48 (see FIG. 4) that adjusts the attraction force. The attraction force adjustment section 48 corresponds to a tension adjuster that adjusts the attraction force of the plurality of attraction sections of the pre-reversing cylinder 44 to adjust the tension in the top-bottom direction of the recording medium P carried on the outer peripheral surface of the pre-reversing cylinder 44. Note that instead of adjusting the attraction force of the plurality of attraction sections of the pre-reversing cylinder 44, the tension of the recording medium P carried on the outer peripheral surface of the pre-reversing cylinder 44 may be adjusted by pressing the recording medium P against the outer peripheral surface side of the pre-reversing cylinder 44 by a press roller (not illustrated).

The conveyance section 20 has the second rotary motor 50 (see FIG. 4) as a second drive source for rotating the pre-reversing cylinder 44, and the second rotary motor 50 is provided at an appropriate position of the center frame 14. In a state where the leading end portion of the recording medium P is gripped and held by the plurality of gripping claws 46 of the pre-reversing cylinder 44, the pre-reversing cylinder 44 is rotated by driving of the second rotary motor 50, thereby conveying the recording medium P having undergone single-sided printing in the conveyance direction. The second rotary motor 50 corresponds to a speed adjuster that adjusts the rotation speed of the pre-reversing cylinder 44 with respect to the rotation speed of the printing cylinder 22.

As shown in FIG. 1, the conveyance section 20 has a reversing swing device 52 as a reversing section that delivers the recording medium P to the printing cylinder 22 in a state where the front and back of the recording medium P delivered from the pre-reversing cylinder 44 are reversed. The reversing swing device 52 is swingably provided between the pre-reversing cylinder 44 and the printing cylinder 22 in the center frame 14.

A plurality of gripping claws 54 (only one gripping claw 54 is illustrated) for gripping and holding a leading end portion of the recording medium P are provided at a distal end portion of the reversing swing device 52. The plurality of gripping claws 54 of the reversing swing device 52 are disposed at intervals in the conveyance width direction. By swinging the reversing swing device 52, the plurality of gripping claws 54 move between a position corresponding to the pre-reversing cylinder 44 (approaching position) and a position corresponding to the printing cylinder 22.

After the plurality of gripping claws 54 of the reversing swing device 52 are positioned at the position corresponding to the pre-reversing cylinder 44, the plurality of gripping claws 54 of the reversing swing device 52 and the plurality of gripping claws 46 of the pre-reversing cylinder 44 perform the gripping change operation of the recording medium P. The plurality of gripping claws 54 of the reversing swing device 52 receive and hold the gripped tail of the recording medium P as the leading end portion of the recording medium P from the pre-reversing cylinder 44.

After the plurality of gripping claws 54 of the reversing swing device 52 are positioned at the positions corresponding to the printing cylinder 22, the plurality of gripping claws 54 of the reversing swing device 52 and the plurality of gripping claws 24 of any one of the claw groups 24G of the printing cylinder 22 perform the gripping change operation of the recording media P. The plurality of gripping claws 24 of any one of the claw groups 24G of the printing cylinder 22 receive and hold the leading end portion of the recording material P from the plurality of gripping claws 54 of the reversing swing device 52. Note that the gripping claws 54 are also referred to as holding claws that hold the leading end portion of the recording medium P.

As described above, the conveyance section 20 includes the printing cylinder 22, the upstream cylinder 28, the first downstream cylinder 32, the second downstream cylinder 36, the third downstream cylinder 40, the pre-reversing cylinder 44, and the reversing swing device 52. The conveyance section 20 conveys the recording medium P in the conveyance direction with the leading end portion of the recording medium P gripped and held by, for example, the plurality of gripping claws 24. The conveyance section 20 conveys the recording medium P in the conveyance direction while the gripping change operation by the plurality of gripping claws 24 and the like is performed.

As shown in FIG. 1, the inkjet printing apparatus 10 includes a first stacking section 56 for stacking a plurality of recording media P, and the first stacking section 56 is provided on the first side frame 16. The first stacking section 56 includes a placing tray 58 for placement the recording medium P, and the placement tray 58 is provided on the first side frame 16 so as to be movable up and down. The placement tray 58 is configured to move up and down in accordance with the amount of recording media P that are a placed target, and the uppermost recording medium P is held at a predetermined height position.

The inkjet printing apparatus 10 includes a feeder section 60 that feeds the recording medium P transported from the placement tray 58 side to the conveyance section 20 side, and the feeder section 60 is provided over a range from the first side frame 16 to the center frame 14. The feeder section 60 is disposed between the printing cylinder 22 and the first stacking section 56. The feeder section 60 includes a plurality of rotatable support rollers 62 and an endless belt 64 provided so as to be wound around the plurality of support rollers 62. Any one of the support rollers 62 is operatively connected to an output shaft of the rotary motor 26. In addition, a transport unit 66 which transports the uppermost recording medium P stacked on the placement tray 58 to the feeder section 60 is provided above the first stacking section 56 in the first side frame 16.

As illustrated in FIGS. 1 to 3, on a downstream end side of the feeder section 60 in the center frame 14, a swing shaft 68 extending in the conveyance width direction is rotatably provided via a pair of eccentric bearings 70. The swing shaft 68 is configured to rotate in forward and reverse directions by a cam mechanism (not illustrated), and the cam mechanism is interlockingly connected to an output shaft of the rotary motor 26. The swing shaft 68 rotates in forward and reverse directions in conjunction with rotation of the printing cylinder 22. The pair of eccentric bearings 70 is rotatably supported by the center frame 14. Adjustment motors 72 for individually adjusting the rotation positions of the pair of eccentric bearings 70 are provided at appropriate positions of the center frame 14.

Base end parts of a plurality of registration sections 74 capable of abutting on the leading end of the recording medium P are integrally connected to the swing shaft 68. In other words, the plurality of registration sections 74 are provided on the downstream end side of the feeder section 60 via the swing shaft 68 and the pair of eccentric bearings 70. The plurality of registration sections 74 are arranged at intervals along the conveyance width direction. Rotating the swing shaft 68 in forward and reverse directions causes the plurality of registration sections 74 to swing in up and down directions about the swing shaft 68.

By individually adjusting the rotation positions of the respective eccentric bearings 70 by driving the respective adjustment motors 72, it is possible to adjust the position of the swing shaft 68 in the conveyance direction and the inclination of the swing shaft 68 with respect to the conveyance width direction. In other words, it is possible to adjust the positions of the plurality of registration sections 74 in the conveyance direction and the inclination of the arrangement direction of the plurality of registration sections 74 with respect to the conveyance width direction. The pair of adjustment motors 72 corresponds to a registration adjuster that adjusts the positions of the plurality of registration sections 74 in the conveyance direction and the inclination of the arrangement direction of the plurality of registration sections 74 with respect to the conveyance width direction.

The belt 64 is circulated by rotation of the plurality of support rollers 62, thereby supplying the recording medium P transported by the transport unit 66 to the conveyance section 20 side. Then, the recording medium P is positioned at a predetermined position on the feeder section 60 such that the leading end surface of the recording medium P abuts on the plurality of registration sections 74 and is parallel to the conveyance width direction.

As illustrated in FIG. 1, the inkjet printing apparatus 10 includes a swing device 76 that delivers the recording medium P from the feeder section 60 side to the upstream cylinder 28. The swing device 76 is swingably provided between the upstream cylinder 28 and the feeder section 60 in the center frame 14. The swing device 76 may be regarded as a part of the conveyance section 20.

A plurality of gripping claws 78 that grip and hold the leading end portion of the recording medium P is disposed at a distal end portion of the swing device 76. The plurality of gripping claws 78 of the swing device 76 are arranged at intervals in the conveyance width direction (see FIG. 3). By swinging the swing device 76, the plurality of gripping claws 78 move between a position corresponding to the downstream end of the feeder section 60 and a position corresponding to the upstream cylinder 28. Note that the gripping claws 78 are also referred to as holding claws that hold the leading end portion of the recording medium P.

After the plurality of gripping claws 78 of the swing device 76 are located at a position corresponding to a downstream end of the feeder section 60, the plurality of gripping claws 78 of the swing device 76 grip and hold a leading end portion of the recording medium P positioned at a predetermined position on the feeder section 60. Note that immediately after the plurality of gripping claws 78 of the swing device 76 hold the leading end portion of the recording medium P, the plurality of registration sections 74 swing downward and separate from the recording medium P.

After the plurality of gripping claws 78 of the swing device 76 are positioned at a position corresponding to the upstream cylinder 28, the plurality of gripping claws 78 of the swing device 76 and the plurality of gripping claws 30 of the upstream cylinder 28 perform a grip change operation of the recording medium P in a state of being close to each other. The plurality of gripping claws 30 of the upstream cylinder 28 receive and hold the leading end portion of the recording medium P from the plurality of gripping claws 78 of the swing device 76.

As shown in FIG. 1, the inkjet printing apparatus 10 is provided with a medium heating section 80 that heats the recording medium P carried on the printing cylinder 22, and the medium heating section 80 is provided on the downstream side of the upstream cylinder 28 in the center frame 14. The medium heating section 80 is disposed to face the outer peripheral surface of the printing cylinder 22. The medium heating section 80 has, for example, an infrared heater or the like, and heats the printing cylinder 22 and the recording medium P so that the recording medium P conveyed by the printing cylinder 22 has a temperature within a predetermined range.

As shown in FIG. 1, the inkjet printing apparatus 10 includes a printing section 82 that performs printing (image formation) on the recording medium P that is being conveyed, and the printing section 82 is provided on the downstream side of the medium heating section 80 in the center frame 14. The printing section 82 is an image forming section that forms an image on a recording medium P being conveyed. The printing section 82 includes a plurality of inkjet sections 84 that eject inks of four colors of yellow (Y), magenta (M), cyan (C), and black (K) to the recording medium P carried on the printing cylinder 22. A plurality of inkjet sections 84 corresponding to inks of four colors of Y, M, C, and K are arranged at intervals along the conveyance direction.

Each inkjet section 84 includes a plurality of inkjet heads (not illustrated) that eject ink onto the recording medium P, and a plurality of nozzles (not illustrated) for ejecting ink are formed at the tip of each inkjet head. The inkjet heads are disposed in a staggered pattern, for example, along the conveyance width direction. In other words, each inkjet section 84 forms a line head including a plurality of inkjet heads.

Ultraviolet curable ink (UV ink) that is cured (solidified) by irradiation with ultraviolet rays, which are one type of energy rays, is used as ink ejected from the inkjet section 84. In particular, UV gel ink, which undergoes a phase change between a gel state and a sol state (liquid state) depending on the temperature, is used among the UV ink. In addition to the UV ink, another ink having a property of being dried or cured by an energy ray such as an infrared ray or an electron beam may be used as the ink ejected from the inkjet section 84.

As shown in FIG. 1, the inkjet printing apparatus 10 is provided with an irradiation section 86 that irradiates the recording medium P on which an image has been formed with ultraviolet light, and the irradiation section 86 is provided on the downstream side of the printing section 82 in the center frame 14. The irradiation section 86 is disposed facing the outer peripheral surface of the printing cylinder 22. The recording medium P is irradiated with the ultraviolet rays from the irradiation section 86, so that the ink on the recording medium P can be cured to fix the image on the recording medium P. Note that in a case where another ink is used as the ink to be ejected from the inkjet section 84, the irradiation section 86 applies energy rays corresponding to the properties of the other ink.

As shown in FIG. 1, the inkjet printing apparatus 10 is provided with an imaging section 88 that captures an image printed on the recording medium P, and the imaging section 88 is provided on the downstream side of the irradiation section 86 in the center frame 14. The imaging section 88 is arranged to face the outer peripheral surface of the printing cylinder 22. The imaging section 88 is a camera in which a plurality of imaging elements such as a plurality of charge-coupled device (CCD) image sensors or a plurality of complementary metal oxide semiconductor (CMOS) image sensors are arranged along the conveyance width direction. For example, the imaging section 88 can capture an image 8,000 times over the entire area of the recording media P having a length of 800 mm, and has a resolution of 0. 1 mm.

When printing is performed on the front surfaces Pa of the recording media P, the imaging section 88 captures images of the plurality of gripping claws 24 gripping and holding the leading end portions of the recording media P, and generates captured images as shown in FIGS. 4A to 4D, for example. When printing is performed on the back surfaces Pb of the recording media P, the imaging section 88 captures images of the plurality of gripping claws 24 gripping and holding the leading end portions of the recording media P, and generates captured images as shown in FIGS. 5A to 5B, for example.

As illustrated in FIG. 1, the inkjet printing apparatus 10 includes a delivery section 90 that conveys the printed recording medium P sent from the third downstream cylinder 40. The delivery section 90 is provided from the center frame 14 to the second side frame 18. The delivery section 90 includes a plurality of rotatable support rollers 92 and an endless belt 94 wound around the plurality of support rollers 92. Any one of the support rollers 92 is operatively connected to an output shaft of the rotary motor 26. The belt 94 is circulated by the rotation of the plurality of support rollers 92, thereby conveying the printed recording medium P sent from the third downstream cylinder 40 in the conveyance direction.

The inkjet printing apparatus 10 includes a second stacking section 96 for stacking a plurality of printed recording media P, and the second stacking section 96 is provided on the second side frame 18. The second stacking section 96 has a placement tray 98 for placing the printed recording medium P thereon. The second stacking section 96 stores the recording media P until a user takes out the recording media P from the placement tray 98.

Note that since single-sided and double-sided printing operations on the recording media P by the inkjet printing apparatus 10 are known, for example, as described in Japanese Unexamined Patent Publication No. 2014-168962, description thereof is omitted.

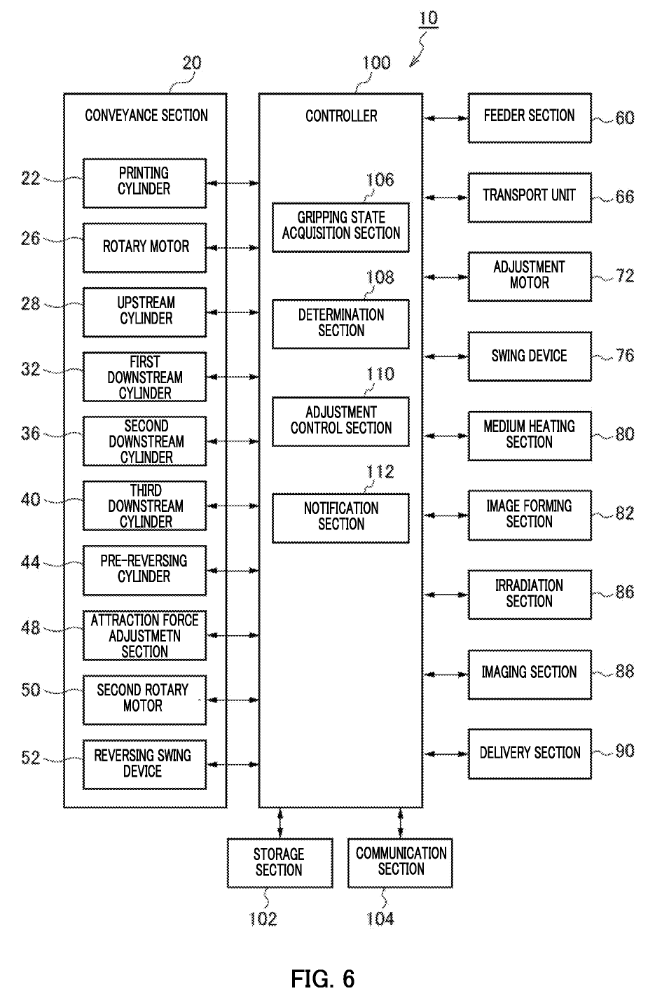

With reference to FIGS. 4A to 6, the control configuration of the inkjet printing apparatus 10 according to the present embodiment is described. FIG. 6 is a control block diagram of the ink jet printing apparatus 10 according to the present embodiment.

As shown in FIG. 6, the inkjet printing apparatus 10 is provided with a controller 100 that controls the rotary motor 26, the feeder section 60, the adjustment motor 72, the medium heating section 80, the printing section 82, the irradiation section 86, and the like. The controller 100 plays a role of governing control of the entire inkjet printing apparatus 10. The controller 100 includes a central processing unit (CPU), a read only memory (ROM), and a random access memory (RAM). A storage section 102 and a communication section 104 are connected to the controller 100.

Thus, the CPU comprehensively controls the overall operation of the inkjet printing apparatus 10. The CPU reads various control programs and data items stored in the ROM, loads them in the RAM, and executes the programs to carry out various calculation processes. The RAM also provides a working memory space for the CPU and stores temporary data. The RAM may include a non-volatile memory.

When performing various kinds of arithmetic processing, the CPU refers to various kinds of data stored in the storage section 102. The storage section 102 is configured by, for example, a nonvolatile semiconductor memory or a hard disk drive.

The controller 100 exchanges various kinds of data with an external device (e.g., a personal computer) connected to a communication network such as a local area network (LAN) or a wide area network (WAN) via a communication section 104. For example, the controller 100 receives a print job transmitted from an external device, and controls the printing section 82 based on image data included in the print job. The communication section 104 is constituted by a communication control card such as a LAN card.

The controller 100 has functions as a gripping state acquisition section 106, a determination section 108, an adjustment control section 110, and a notification section 112 by executing various control programs. The contents of the gripping state acquisition section 106, the determination section 108, the adjustment control section 110, and the notification section 112 are as follows.

As shown in FIGS. 4A to 6, the gripping state acquirer 106 acquires the gripping states of the plurality of gripping claws 24 with respect to the recording media P based on the captured image generated by the imaging section 88. When the gripping state acquirer 106 acquires the gripping states of the plurality of gripping claws 24, for example, a known image processing method such as edge detection processing is used. The imaging section 88 and the gripping state acquirer 106 correspond to a gripping state detector that detects the gripping state of the plurality of gripping claws 24 with respect to the recording medium P.

When printing is performed on the front surface Pa of the recording medium P, the gripping state acquirer 106 acquires the gripping states of the plurality of gripping claws 24 with respect to the front surface Pa of the recording medium P, based on the captured image generated by the imaging section 88. In other words, when printing is performed on the front surface Pa of the recording medium P, the imaging section 88 and the gripping state acquirer 106 as the gripping state detector detect the gripping states of the plurality of gripping claws 24 with respect to the front surface Pa of the recording medium P.

When printing is performed on the back surface Pb of the recording medium P, the gripping state acquirer 106 acquires the gripping states of the plurality of gripping claws 24 with respect to the back surface Pb of the recording medium P, based on the captured image generated by the imaging section 88. In other words, when printing is performed on the back surface Pb of the recording medium P, the imaging section 88 and the gripping state acquirer 106 as the gripping state detector detect the gripping states of the plurality of gripping claws 24 with respect to the front surface Pa of the recording medium P.

Specifically, the gripping state acquirer 106 acquires the gripping amounts of the plurality of gripping claws 24 as the gripping states of the plurality of gripping claws 24 based on the captured image from the imaging section 88. In other words, the imaging section 88 and the gripping state acquirer 106 as the gripping state detector detect the gripping amount of the plurality of gripping claws 24 as the gripping state of the plurality of gripping claws 24.

The gripping state acquirer 106 acquires the difference between the maximum value and the minimum value of the gripping amount of the plurality of gripping claws 24 as the gripping state of the plurality of gripping claws 24 based on the captured image generated by the imaging section 88. In other words, the imaging section 88 and the gripping state acquirer 106 as the gripping state detector detect the difference between the maximum value and the minimum value of the gripping amounts of the plurality of gripping claws 24 as the gripping state of the plurality of gripping claws 24.

The gripping state acquirer 106 acquires, as the gripping state of the plurality of gripping claws 24, the distance from the lateral end of the gripping claw 24 disposed outside in the conveyance width direction to the lateral end of the recording medium P, based on the captured image generated by the imaging section 88. In other words, the imaging section 88 and the gripping state acquirer 106 as the gripping state detector detect the distance from the lateral end of the gripping claw 24 arranged on the outside in the conveyance width direction to the lateral end of the recording medium P.

The determiner 108 determines, based on the acquisition result of the gripping state acquirer 106, whether or not the gripping states of the plurality of gripping claws 24 are proper gripping states. When the gripping states of the plurality of gripping claws 24 are proper gripping states, the determiner 108 determines that there is no abnormality in the gripping states of the plurality of gripping claws 24. When the gripping states of the plurality of gripping claws 24 are not appropriate gripping states, the determiner 108 determines that there is an abnormality in the gripping states of the plurality of gripping claws 24.

That is, the determiner 108 determines the presence or absence of an abnormality in the gripping states of the plurality of gripping claws 24 based on the acquisition result of the gripping state acquirer 106. The determiner 108 determines the presence or absence of an abnormality in the gripping state of the plurality of gripping claws 24 with respect to the front surface Pa of the recording medium P, and determines the presence or absence of an abnormality in the gripping state of the plurality of gripping claws 24 with respect to the back surface Pb of the recording medium P. Note that the acquisition result of the gripping state acquirer 106 is synonymous with the detection result of the gripping state detector.

Specifically, the determiner 108 determines whether or not the gripping amount of the plurality of gripping claws 24 as the acquisition result of the gripping state acquirer 106 is within a preset appropriate gripping amount range. For example, as shown in FIGS. 4A and 5A, when the gripping amounts of the plurality of gripping claws 24 are within the appropriate gripping amount range, the determiner 108 determines that there is no abnormality in the gripping states of the plurality of gripping claws 24. For example, as illustrated in FIGS. 4B and 5B, if the gripping amount of the plurality of gripping claws 24 is outside of the appropriate gripping amount range, the determiner 108 determines that there is an abnormality in the gripping state of the plurality of gripping claws 24. Here, the appropriate gripping amount range is, for example, 3 ± 1 mm.

The determiner 108 determines whether the difference between the maximum value and the minimum value of the gripping amounts of the plurality of gripping claws 24, as the acquisition result of the gripping state acquirer 106, is within a preset appropriate difference range. For example, as shown in FIG. 4A, when the difference is within an appropriate difference range, the determiner 108 determines that there is no abnormality in the gripping state of the plurality of gripping claws 24. For example, as shown in FIG. 4C, when the difference is out of the appropriate difference range, the determiner 108 determines that there is an abnormality in the gripping state of the plurality of gripping claws 24. Here, the appropriate difference range is, for example, 1 mm.

The determiner 108 determines whether the distance from the lateral end of the gripping claw 24 disposed outside in the conveyance width direction to the lateral end of the recording medium P, as the acquisition result of the gripping state acquirer 106, is within a preset appropriate distance range. For example, as shown in FIG. 4A, when the distances are within the proper distance range, the determiner 108 determines that there is no abnormality in the gripping states of the plurality of gripping claws 24. For example, as shown in FIG. 4C, when the distances are out of the proper distance range, the determiner 108 determines that the gripping states of the plurality of gripping claws 24 are abnormal. Here, the appropriate distance range is, for example, 1 ± 0. 5 mm.

In a case where it is determined that there is an abnormality in the gripping state of the plurality of gripping claws 24 with respect to the front surface Pa of the recording medium P, the adjustment controller 110 controls the adjustment operation of each adjustment motor 72 as the registration adjuster as follows. The adjustment controller 110 controls the adjustment operation of the pair of adjustment motors 72 so that the gripping state of the plurality of gripping claws 24 on the front surface Pa of the recording medium P becomes an appropriate gripping state, based on the acquisition result of the gripping state acquirer 106.

When it is determined that there is an abnormality in the gripping state of the plurality of gripping claws 24 with respect to the back surface Pb of the recording media P, the adjustment controller 110 controls the adjustment operation of the second rotary motor 50 as follows. The adjustment controller 110 controls, based on the result acquired by the gripping state acquirer 106, the adjustment operation of the second rotary motor 50 so that the gripping state of the plurality of gripping claws 24 with respect to the back surface Pb of the recording medium P becomes an appropriate gripping state. The adjustment controller 110 controls the adjustment operation of the second rotary motor 50 on condition that the adjustment operation of the pair of adjustment motors 72 has been performed.

When it is determined that there is an abnormality in the gripping states of the plurality of gripping claws 24 with respect to the back surface Pb of the recording medium P, the adjustment controller 110 may control the adjustment operation of the attraction force adjustment section 48 as follows. The adjustment controller 110 controls the attraction force adjustment section 48 so that the gripping state of the plurality of gripping claws 24 on the back surface Pb of the recording medium P becomes an appropriate gripping state, based on the acquisition result of the gripping state acquirer 106. The adjustment controller 110 controls the adjustment operation of the attraction force adjustment section 48 on condition that the adjustment operation of the pair of adjustment motors 72 has been performed.

When it is determined that there is an abnormality in the gripping states of the plurality of gripping claws 24, the notification section 112 provides notification by displaying the determination result on, for example, a display section (not illustrated).

With the configuration of the inkjet printing apparatus 10 according to the present embodiment, as described above, the imaging section 88 and the gripping state acquirer 106 as the gripping state detector detect the gripping states of the plurality of gripping claws 24 on the recording medium P. The determiner 108 determines the presence or absence of abnormality in the gripping states of the plurality of gripping claws 24 based on the acquisition result of the gripping state acquirer 106 (the detection result of the gripping state detector). Therefore, when the gripping states of the plurality of gripping claws 24 are not in the appropriate gripping state, the determiner 108 determines that there is an abnormality in the gripping states of the plurality of gripping claws 24, thus avoiding continuation of the state of not being in the appropriate gripping state. In particular, since the notification section 112 provides notification of the determination result, it is possible to quickly avoid a state in which the gripping state is not appropriate.

Therefore, according to the inkjet printing apparatus 10 according to the present embodiment, damage to the leading end portion of the recording medium P can be suppressed while the recording medium P is prevented from falling off from the printing cylinder 22 or the like of the conveyance section 20.

Furthermore, according to the configuration of the inkjet printing apparatus 10 according to the present embodiment, as described above, the imaging section 88 and the gripping state acquirer 106 as the gripping state detector detect the gripping amount of the plurality of gripping claws 24 as the gripping state of the plurality of gripping claws 24. The determiner 108 determines whether the difference between the maximum value and the minimum value of the gripping amounts of the plurality of gripping claws 24, as the acquisition result of the gripping state acquirer 106 (the detection result of the gripping state detector), is within an appropriate difference range. Therefore, the determiner 108 can appropriately determine the presence or absence of abnormality in the gripping states of the plurality of gripping claws 24.

With the inkjet printing apparatus 10 according to the present embodiment, it is possible to efficiently perform the processing of determining the presence or absence of an abnormality in the gripping state of the plurality of gripping claws 24.

With the structure of the inkjet printing apparatus 10 according to the present embodiment, the imaging section 88 and the gripping state acquirer 106 as the gripping state detector detect the difference between the maximum value and the minimum value of the gripping amounts of the plurality of gripping claws 24 as the gripping state of the plurality of gripping claws 24. The determiner 108 determines whether the difference between the maximum value and the minimum value of the gripping amounts of the plurality of gripping claws 24, as the acquisition result of the gripping state acquirer 106 (the detection result of the gripping state detector), is within an appropriate difference range. Therefore, the determiner 108 can appropriately determine the presence or absence of abnormality in the gripping states of the plurality of gripping claws 24.

With the inkjet printing apparatus 10 according to the present embodiment, it is possible to efficiently perform the processing of determining the presence or absence of an abnormality in the gripping state of the plurality of gripping claws 24.

Furthermore, according to the configuration of the inkjet printing apparatus 10 according to the present embodiment, the imaging section 88 and the gripping state acquirer 106 detect, as the gripping states of the plurality of gripping claws 24, the distances from the lateral ends of the gripping claws 24 arranged on the outer sides in the conveyance width direction to the lateral ends of the recording medium P. The determiner 108 determines whether or not the distance as the acquisition result of the gripping state acquirer 106 (the detection result of the gripping state detector) is in an appropriate distance range. Therefore, the determiner 108 can appropriately determine the presence or absence of abnormality in the gripping states of the plurality of gripping claws 24.

With the inkjet printing apparatus 10 according to the present embodiment, it is possible to efficiently perform the processing of determining the presence or absence of an abnormality in the gripping state of the plurality of gripping claws 24.

With the configuration of the inkjet printing apparatus 10 according to the present embodiment, if it is determined that there is an abnormality in the gripping state of the plurality of gripping claws 24 on the front surface Pa of the recording medium P, the adjustment controller 110 controls the adjustment operation of the pair of adjustment motors 72 as described above. Therefore, the gripping state of the plurality of gripping claws 24 on the front surface Pa of the recording medium P can be automatically adjusted to a proper gripping state.

Therefore, according to the inkjet printing apparatus 10 according to the present embodiment, the utility value of the inkjet printing apparatus 10 can be increased.

With the configuration of the inkjet printing apparatus 10 according to the present embodiment, if it is determined that there is an abnormality in the gripping state of the plurality of gripping claws 24 on the back surface Pb of the recording media P, the adjustment controller 110 controls the adjustment operation of the second rotary motor 50 as described above. Therefore, the gripping state of the plurality of gripping claws 24 on the back surface Pb of the recording medium P can be automatically adjusted to a proper gripping state.

Therefore, according to the inkjet printing apparatus 10 according to the present embodiment, the utility value of the inkjet printing apparatus 10 can be increased.

With the configuration of the inkjet printing apparatus 10 according to the present embodiment, if it is determined that there is an abnormality in the gripping state of the plurality of gripping claws 24 on the back surface Pb of the recording medium P, the adjustment controller 110 controls the attraction force adjustment section 48 as described above. Therefore, the gripping state of the plurality of gripping claws 24 on the back surface Pb of the recording medium P can be automatically adjusted to a proper gripping state.

Therefore, according to the inkjet printing apparatus 10 according to the present embodiment, the utility value of the inkjet printing apparatus 10 can be increased.

Although the present embodiment has been specifically described above, the present invention is not limited to the above-described specific embodiment. Various modifications and changes can be made to the specific examples described in the above embodiments within the scope of the spirit of the present invention described in the claims. For example, instead of the imaging section 88 and the gripping state acquirer 106 as the gripping state detector detecting the gripping state of the plurality of gripping claws 24 with respect to the recording medium P, the gripping state of any one of the plurality of gripping claws 24 may be detected. The technical idea applied to the inkjet printing apparatus 10 may be applied to a printing apparatus other than the inkjet printing apparatus 10, such as an offset sheet-fed printing press.

Although embodiments of the present invention have been described and illustrated in detail, it is clearly understood that the same is by way of illustration and example only and not limitation, the scope of the present invention should be interpreted by terms of the appended claims.

What is claimed is:

1. A printing apparatus, comprising:
a conveyer that conveys a recording medium in a conveyance direction in a state where a leading end portion of the recording medium is gripped and held by a gripping claw;
a printer that performs printing on the recording medium being conveyed; and
a hardware processor that functions as:
a gripping state detector configured to detect a gripping state of the gripping claw with respect to the recording medium, and
a determiner configured to determine presence or absence an abnormality in the gripping state of the gripping claw based on a detection result of the gripping state detector.

2. The printing apparatus according to claim 1, wherein:
the conveyer includes a plurality of the gripping claws, and the plurality of gripping claws are arranged along a conveyance width direction orthogonal to the conveyance direction, and
the gripping state detector detects the gripping state of at least one gripping claw of the plurality of gripping claws.

3. The printing apparatus according to claim 2, wherein:
the gripping state detector detects a gripping amount of the at least one gripping claw of the plurality of gripping claws as the gripping state of the at least one gripping claw, and
the determiner determines whether or not the gripping amount as the detection result of the gripping state detector is within a preset appropriate gripping amount range.

4. The printing apparatus according to claim 2, wherein:
the gripping state detector detects a difference between a maximum value and a minimum value of gripping amounts of the plurality of gripping claws as the gripping state of the at least one gripping claw, and
the determiner determines whether or not the difference as the detection result of the gripping state detector is within a preset appropriate difference range.

5. The printing apparatus according to claim 2, wherein:
the gripping state detector detects, as the gripping state of the at least one gripping claw, a distance from a lateral end of the recording medium to a lateral end of the gripping claw among the plurality of gripping claws which is disposed on an outer side in the conveyance width direction, and
the determiner determines whether or not the distance as the detection result of the gripping state detector is within a preset appropriate distance range.

6. The printing apparatus according to claim 2, further comprising:
a feeder section that feeds the recording medium to the conveyer;
a plurality of registration sections that are provided on a downstream end side of the feeder section, arranged along the conveyance width direction orthogonal to the conveyance direction, and capable of abutting a leading end of the recording medium; and
a registration adjuster that adjusts positions of the plurality of registration sections in the conveyance direction and/or an inclination of an arrangement direction of the plurality of registration sections with respect to the conveyance width direction, wherein
the hardware processor functions as an adjustment controller that, when it is determined that the gripping state of the at least one gripping claw is abnormal, controls an adjustment operation of the registration adjuster based on the detection result of the gripping state detector such that gripping states of the plurality of gripping claws become appropriate gripping states.

7. The printing apparatus according to claim 1, wherein
the conveyer includes a printing cylinder that is provided with the gripping claw on an outer peripheral surface side and rotates while carrying the recording medium.

8. The printing apparatus according to claim 1, wherein
the printer includes an inkjet section that forms an image by ejecting ink onto the recording medium being conveyed.

9. The printing apparatus according to claim 1, further comprising:
an imager configured to capture an image of the gripping claw gripping and holding the leading end portion of the recording medium to generate a captured image, wherein
the hardware processor that functions as the gripping state detector functions as a gripping state acquirer configured to acquire the gripping state of the gripping claw based on the captured image generated by the imager.

10. The printing apparatus according to claim 9, wherein
the imager is a camera that reads an image printed on the recording medium.

11. The printing apparatus according to claim 2, wherein:
the gripping state detector detects a state of the at least one gripping claw with respect to a front surface of the recording medium when printing is performed on the front surface of the recording medium, and detects a state of the at least one gripping claw with respect to a back surface of the recording medium when printing is performed on the back surface of the recording medium, and
based on the detection result of the gripping state detector, the determiner determines presence or absence of an abnormality in the state of the at least one gripping claw with respect to the front surface of the recording medium, and determines presence or absence of an abnormality in the state of the at least one gripping claw with respect to the back surface of the recording medium.

12. The printing apparatus according to claim 11, wherein
the conveyer includes:
a printing cylinder that is provided with the plurality of gripping claws on an outer peripheral surface side and rotates while carrying the recording medium,
a pre-reversing cylinder that is disposed at a position facing the printing cylinder, is provided with the plurality of gripping claws on an outer peripheral surface side, and rotates while carrying the recording medium delivered from the printing cylinder side, and
a reversing section that is disposed between the printing cylinder and the pre-reversing cylinder and delivers the recording medium to the printing cylinder in a state where a front and back of the recording medium delivered from the pre-reversing cylinder are reversed.

13. The printing apparatus according to claim 12, further comprising:
a feeder section that feeds the recording medium to the conveyer side;
a plurality of registration sections that are provided on a downstream end side of the feeder section, arranged along the conveyance width direction orthogonal to the conveyance direction, and capable of abutting a leading end of the recording medium; and
a registration adjuster that adjusts positions of the plurality of registration sections in the conveyance direction and/or an inclination of an arrangement direction of the plurality of registration sections with respect to the conveyance width direction, wherein
the hardware processor functions as an adjustment controller that, when it is determined that the gripping state of the at least one gripping claw with respect to the front surface is abnormal, controls an adjustment operation of the registration adjuster based on the detection result of the gripping state detector such that gripping states of the plurality of gripping claws become appropriate gripping states.

14. The printing apparatus according to claim 13, further comprising:
a motor that functions as a speed adjuster configured to adjust a rotation speed of the pre-reversing cylinder with respect to a rotation speed of the printing cylinder, wherein
when it is determined that the gripping state of the at least one gripping claw with respect to the back surface is abnormal, the adjustment controller controls an adjustment operation of the speed adjuster based the detection result of the gripping state detector such that gripping states of the plurality of gripping claws become appropriate gripping states.

15. The printing apparatus according to claim 14, wherein
the adjustment controller controls the adjustment operation of the speed adjuster on condition that the adjustment controller has controlled the adjustment operation of the registration adjuster.

16. The printing apparatus according to claim 13, wherein:
the hardware processor functions as a tension adjuster that adjusts a tension of the recording medium carried on the outer peripheral surface of the pre-reversing cylinder, and
when it is determined that the gripping state of the at least one gripping claw with respect to the back surface is abnormal, the adjustment controller controls an adjustment operation of the tension adjuster based the detection result of the gripping state detector such that gripping states of the plurality of gripping claws become appropriate gripping states.

17. The printing apparatus according to claim 16, wherein
the adjustment controller controls the adjustment operation of the tension adjuster on condition that the adjustment controller has controlled the adjustment operation of the registration adjuster.

18. The printing apparatus according to claim 1, wherein
when it is determined that there is an abnormality in the gripping state of the gripping claw, the hardware processor functions as a notifier that notifies a determination result.
